(19) United States
(12) Patent Application Publication
(10) Pub. No.: US 2019/0335743 A1
(43) Pub. Date: Nov. 7, 2019

(54) Water Feature Simulating Assembly

(71) Applicants: Aaron Payne, Tye, TX (US); Richard Hamric, Abilene, TX (US); Richard Van Druten, Plano, TX (US)

(72) Inventors: Aaron Payne, Tye, TX (US); Richard Hamric, Abilene, TX (US); Richard Van Druten, Plano, TX (US)

(21) Appl. No.: 15/969,963

(22) Filed: May 3, 2018

(51) Int. Cl. A01M 31/06

(52) U.S. Cl. CPC A01M 31/06

(57) ABSTRACT

A water feature simulating assembly for attracting birds includes a panel that is configured to position on a surface. An illustration is coupled to an upper face of the panel. The illustration depicts a water feature so that the illustration is configured to attract birds. Each of a plurality of couplers is coupled to the panel. Each coupler is configured to couple to the surface so that the plurality of couplers is configured to couple the panel to the surface.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to simulating assemblies and more particularly pertains to a new simulating assembly for attracting birds.

### BRIEF SUMMARY OF THE INVENTION

An embodiment of the disclosure meets the needs presented above by generally comprising a panel that is configured to position on a surface. An illustration is coupled to an upper face of the panel. The illustration depicts a water feature so that the illustration is configured to attract birds. Each of a plurality of couplers is coupled to the panel. Each coupler is configured to couple to the surface so that the plurality of couplers is configured to couple the panel to the surface.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an in-use view of a water feature simulating assembly according to an embodiment of the disclosure.

FIG. 2 is a top view of an embodiment of the disclosure.

FIG. 3 is a cross-sectional view of an embodiment of the disclosure.

### DETAILED DESCRIPTION OF THE INVENTION

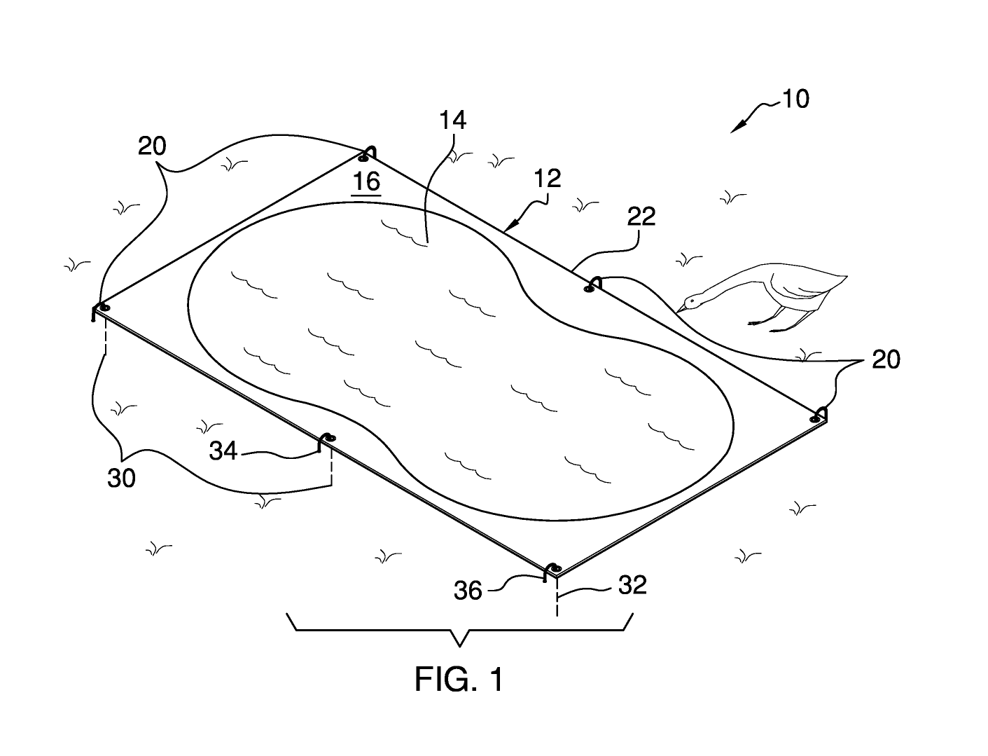

With reference now to the drawings, and in particular to FIGS. 1 through 3 thereof, a new simulating assembly embodying the principles and concepts of an embodiment of the disclosure and generally designated by the reference numeral 10 will be described.

As best illustrated in FIGS. 1 through 3, the water feature simulating assembly 10 generally comprises a panel 12 that is configured to position on a surface. The panel 12 is flexible so that the panel 12 is configured to be rolled and folded when not in use. The panel 12 is substantially rectangularly shaped.

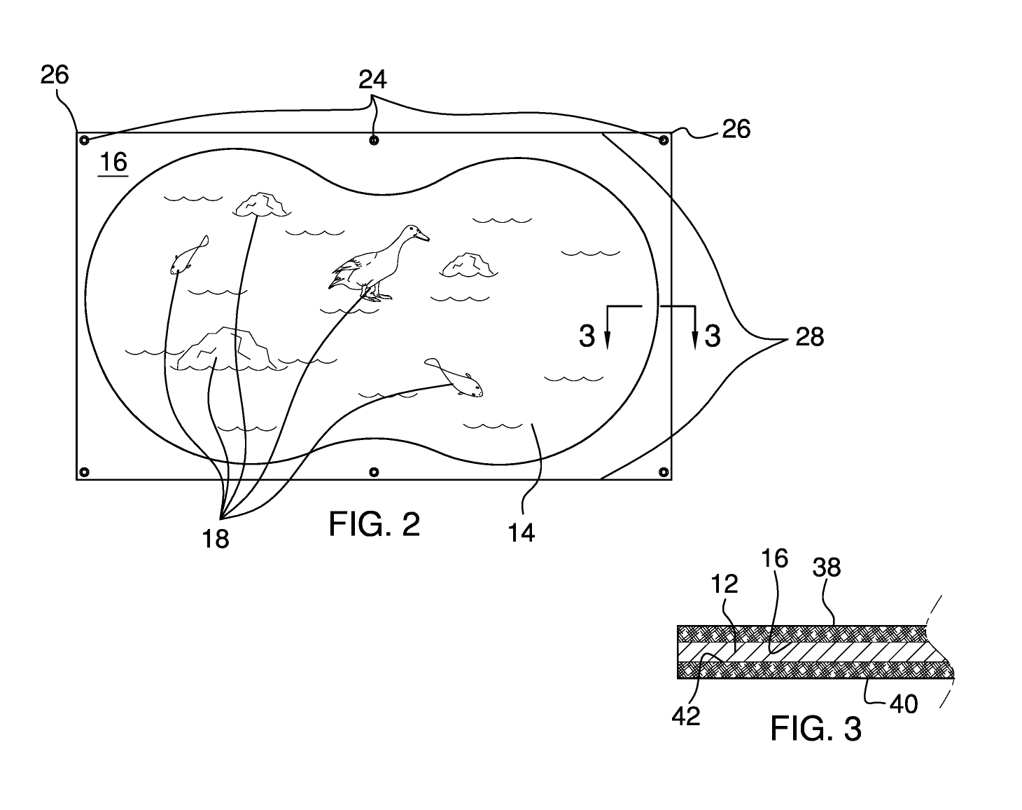

An illustration 14 is coupled to an upper face 16 of the panel 12, as shown in FIG. 2. The illustration 14 depicts a water feature, such as a puddle, a pond, a stream, or the like, so that the illustration 14 is configured to attract birds. The illustration 14 comprises images 18 selected from a plurality of images 18. Each image 18 depicts a respective feature so that the plurality of images 18 depicts of variety of features, such as rocks, plants, fish, water of a variety of colors and clarities, or the like. The illustration 14 is configured to attract a variety of bird species. The illustration 14 is integral to the panel 12.

A plurality of couplers 20 is coupled to the panel 12. Each coupler 20 is configured to couple to the surface so that the plurality of couplers 20 is configured to couple the panel 12 to the surface. Each coupler 20 is positioned proximate to a perimeter 22 of the panel 12. The couplers 20 serve to flatten the mat and to prevent movement of the panel 12 from by wind.

Each of a plurality of grommets 24 is positioned in the panel 12 proximate to the perimeter 22, as shown in FIG. 2. Each grommet 24 is configured to insert a respective item of mounting hardware to couple the panel 12 to the surface. The plurality of grommets 24 comprises four grommets 24 that are positioned singly in the panel 12 proximate to each corner 26 of the panel 12, as shown in FIG. 2. The plurality of grommets 24 also comprises two grommets 24 that are positioned singly in opposing sides 28 of the panel 12 substantially equally distant from associated corners 26 of the panel 12.

The assembly 10 also comprises a plurality of stakes 30, as shown in FIG. 1. Each stake 30 is configured to insert through a respective grommet 24 into the surface to couple the panel 12 to the surface. Each stake 30 comprises a rod 32 that has an upper end 34. The rod 32 is arcuate proximate to the upper end 34 to define a hook 36. The rod 32 is positioned to insert through the respective grommet 24 so that the hook 36 extends past the perimeter 22 of the panel 12. The hook 36 couples the rod 32 to the panel 12 and the panel 12 to the surface.

A first sheet 38 is coupled to the upper face 16 of the panel 12 and extends over the illustration 14, as shown in FIG. 3. The grommets 24 are positioned through the first sheet 38. The first sheet 38 is substantially transparent so that the illustration 14 is visible through the first sheet 38. The first sheet 38 is configured to protect the panel 12 and the illustration 14 from the elements.

A second sheet 40 is coupled to a lower face 42 of the panel 12, as shown in FIG. 3. The grommets 24 are positioned through the second sheet 40. The second sheet 40 is configured to protect the panel 12 from the elements.

In use, the panel 12 is positioned on the surface. The stakes 30 are inserted through the grommets 24 into the surface to couple the panel 12 to the surface. The illustration 14 on the panel 12 attracts the birds to the panel 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A water feature simulating assembly comprising:
a panel configured for positioning on a surface;
an illustration coupled to an upper face of said panel, said illustration depicting a water feature wherein said illustration is configured for attracting birds; and
a plurality of couplers coupled to said panel, each said coupler being configured for coupling to the surface wherein said plurality of couplers is configured for coupling said panel to the surface.

2. The assembly of claim 1, further including said panel being flexible wherein said panel is configured for rolling and folding.

3. The assembly of claim 1, further including said panel being substantially rectangularly shaped.

4. The assembly of claim 1, further including said illustration comprising images selected from a plurality of images, each said image depicting a respective feature such that said plurality of images depicts of variety of features wherein said illustration is configured for attracting a variety of bird species.

5. The assembly of claim 1, further including said illustration being integral to said panel.

6. The assembly of claim 1, further including each said coupler being positioned proximate to a perimeter of said panel.

7. The assembly of claim 6, further including a plurality of grommets, each said grommet being positioned in said panel proximate to said perimeter wherein each said grommet is configured for inserting a respective item of mounting hardware for coupling said panel to the surface.

8. The assembly of claim 7, further including said plurality of grommets comprising four said grommets positioned singly in said panel proximate to each corner of said panel.

9. The assembly of claim 8, further including said plurality of grommets comprising two said grommets positioned singly in opposing sides of said panel substantially equally distant from associated said corners of said panel.

10. The assembly of claim 7, further including a plurality of stakes wherein each said stake is configured for inserting through a respective said grommet into the surface for coupling said panel to the surface.

11. The assembly of claim 10, further including each said stake comprising a rod having an upper end, said rod being arcuate proximate to said upper end defining a hook wherein said rod is positioned for inserting through said respective said grommet such that said hook extends past said perimeter of said panel for coupling said rod to said panel and said panel to the surface.

12. The assembly of claim 7, further including a first sheet coupled to said upper face of said panel and extending over said illustration, said grommets being positioned through said first sheet, said first sheet being substantially transparent such that said illustration is visible through said first sheet wherein said first sheet is configured for protecting said panel and said illustration from the elements.

13. The assembly of claim 12, further including a second sheet coupled to a lower face of said panel, said grommets being positioned through said second sheet, wherein said second sheet is configured for protecting said panel from the elements.

14. A water feature simulating assembly comprising:
a panel configured for positioning on a surface, said panel being flexible wherein said panel is configured for rolling and folding, said panel being substantially rectangularly shaped;
an illustration coupled to an upper face of said panel, said illustration depicting a water feature wherein said illustration is configured for attracting birds, said illustration comprising images selected from a plurality of images, each said image depicting a respective feature such that said plurality of images depicts of variety of features wherein said illustration is configured for attracting a variety of bird species, said illustration being integral to said panel;
a plurality of couplers coupled to said panel, each said coupler being configured for coupling to the surface wherein said plurality of couplers is configured for coupling said panel to the surface, each said coupler being positioned proximate to a perimeter of said panel;
a plurality of grommets, each said grommet being positioned in said panel proximate to said perimeter wherein each said grommet is configured for inserting a respective item of mounting hardware for coupling said panel to the surface, said plurality of grommets comprising four said grommets positioned singly in said panel proximate to each corner of said panel, said plurality of grommets comprising two said grommets positioned singly in opposing sides of said panel substantially equally distant from associated said corners of said panel;
a plurality of stakes wherein each said stake is configured for inserting through a respective said grommet into the surface for coupling said panel to the surface, each said stake comprising a rod having an upper end, said rod being arcuate proximate to said upper end defining a hook wherein said rod is positioned for inserting through said respective said grommet such that said hook extends past said perimeter of said panel for coupling said rod to said panel and said panel to the surface;
a first sheet coupled to said upper face of said panel and extending over said illustration, said grommets being positioned through said first sheet, said first sheet being substantially transparent such that said illustration is visible through said first sheet wherein said first sheet is configured for protecting said panel and said illustration from the elements; and
a second sheet coupled to a lower face of said panel, said grommets being positioned through said second sheet, wherein said second sheet is configured for protecting said panel from the elements.
